(19) United States
(12) Patent Application Publication
(10) Pub. No.: US 2009/0046098 A1
(43) Pub. Date: Feb. 19, 2009

(54) PRIMITIVE BINNING METHOD FOR TILE-BASED RENDERING

(75) Inventors: Massimiliano Barone, Bresso (IT); Mirko Falchetto, Milzano (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS S.R.L., Agrate Brianza (IT)

(21) Appl. No.: 11/838,762

(22) Filed: Aug. 14, 2007

(51) Int. Cl. G06T 15/00; G06T 15/40; G09G 5/00

(52) U.S. Cl. 345/420; 345/421; 345/423; 345/620

(57) ABSTRACT

A primitive binning method includes detecting border tiles of a primitive defined by at least three vertexes. The detecting includes: defining a left edge and a right edge of the primitive compared to a direction of exploring tiles; calculating a slope sign for the left edge using an edge equation for the left edge; calculating a slope sign for the right edge using an edge equation for the right edge; and checking if a tile is crossed by one of the edges by evaluating an edge equation of a single corner of a tile. The corner is selected according to the one of the edges being a left or a right edge and according to the slope sign of the one of the edges.

### BACKGROUND

1. Field of the Invention

The present invention relates to the technical field of graphic rendering and, in particular, to a primitive binning method for use in a tile-based rendering system, for example in a sort-middle technique.

2. Description of the Related Art

A virtual three dimensional (3D) model (or simply “3D model”) is comprised of primitives in the form of polygons, such as triangles, which represent the skin of the 3D model. A graphic 3D engine draws polygons from the 3D model onto a two-dimensional (2D) surface, such as a screen.

A summary of the prior art rendering process can be found in: “Fundamentals of Three-Dimensional Computer Graphics”, by Watt, Chapter 5: The Rendering Process, pages 97 to 113, published by Addison-Wesley Publishing Company, Reading, Mass., 1989, reprinted 1991, ISBN 0-201-15442-0.

In a traditional pipeline, the primitives are processed in a submission order. A more efficient method is to break up the frame buffer into individual subsections (tiles) and to render them individually. Each tile includes one or more polygons or, more typically, a portion of one or more polygons.

A tile based rendering employs therefore a way to associate tiles covered by a primitive. A rasteriser renders all primitives of one tile, so which tile is covered by that primitive is found first.

To reduce the amount of tiles that each polygon is assigned to, a primitive or polygon binning method may be used. A polygon binning method excludes tiles that do not include any polygons or portions thereof prior to rasterization. The binning process also accomplishes some rasterization setup by identifying which polygons are contained by each tile.

A simple binning method provides for constructing a bounding box around the primitive. However, many tiles of the bounding box may still be outside the primitive.

According to another approach, the binning method calculates the equations of the lines formed by the edges of the primitive (in the standard y=mx+c format) and then tracks up the lines from vertex to vertex enabling the tiles which are transversed. This (depending on the size of the triangle) may leave some tiles in the middle. These can be checked and enabled by traveling along each row and enabling all tiles which are situated between two previously enabled tiles. This method requires to calculate reciprocal values and has therefore a very high cost.

According to an alternative method, the equations of the lines which form the sides of a polygon are not used and edge equations, which can be derived from a matrix formed by the vertex co-ordinates (“outcode method”), are employed. Therefore, each side of the triangle is associated with an edge equation. Any point on the line will satisfy this equation, with points on one side giving a positive evaluation and on the other a negative result. This property can be used to determine on which side of a line a point is, and therefore, by using three edge equations, whether a point is inside a triangle or not. In the present case, a tile is considered to be covered by a primitive if at least one of its corners is within the triangle. Therefore, this method requires checking against three edge equations for all the corners of the tiles. If all four corners of any tile are outside any of three edges, then that tile can be ignored.

According to another approach, called “midpoint method”, triangles are tiled by finding the midpoint of the edges and then disabling blocks of tiles that are outside these points. If a high accuracy is desired, also this method turns out to be quite cumbersome.

There is therefore the need of associating tiles to primitives in a more efficient way, in order to reduce the amount of processing to be performed by the 3D graphic engine.

### BRIEF SUMMARY

One embodiment of the present invention provides a primitive binning method that includes detecting border tiles of a primitive defined by at least three vertexes. The detecting includes:

defining a left edge and a right edge of the primitive compared to a direction of exploring tiles;

calculating a slope sign for the left edge using an edge equation for the left edge and calculating a slope sign for the right edge using an edge equation for the right edge; and

checking if a tile is crossed by one of the edges by evaluating an edge equation of a single corner of a tile, the corner being selected according to the one of the edges being a left or a right edge and according to the slope sign of the one of the edges.

### BRIEF DESCRIPTION OF THE SEVERAL VIEWS OF THE DRAWINGS

The features and advantages of the method according to various embodiment of the invention will be apparent from the description given below, with reference to the following figures, in which:

FIG. 1 shows a graphic system in accordance with one embodiment of the invention;

FIG. 2 shows an example of graphic module in accordance with one embodiment of the invention;

FIG. 3 shows an example of a part of the graphic module in mode detail;

FIG. 4 shows an example of a geometry stage employable in said graphic module;

FIG. 5 shows an intersection between a frustum and the screen;

FIG. 6 is a flow chart of the binning method of one embodiment of the invention;

FIG. 7 represents a bounding box around a triangle according to one embodiment of the invention;

FIGS. 8A-8D schematically represents the selection of a tile corner and of the tiles exploration direction according to one embodiment;

FIGS. 9A and 9B schematically illustrate the step of determining the coefficients sign of the edge equations according to one embodiment;

FIG. 10 shows the splitting of a triangle into two sub-triangles according to one embodiment;

FIGS. 11A-11D schematically show an incremental tiles exploration process along edges according to one embodiment; and

FIG. 12 schematically illustrates how the tiles exploration of a triangle is performed according to one embodiment.

### DETAILED DESCRIPTION

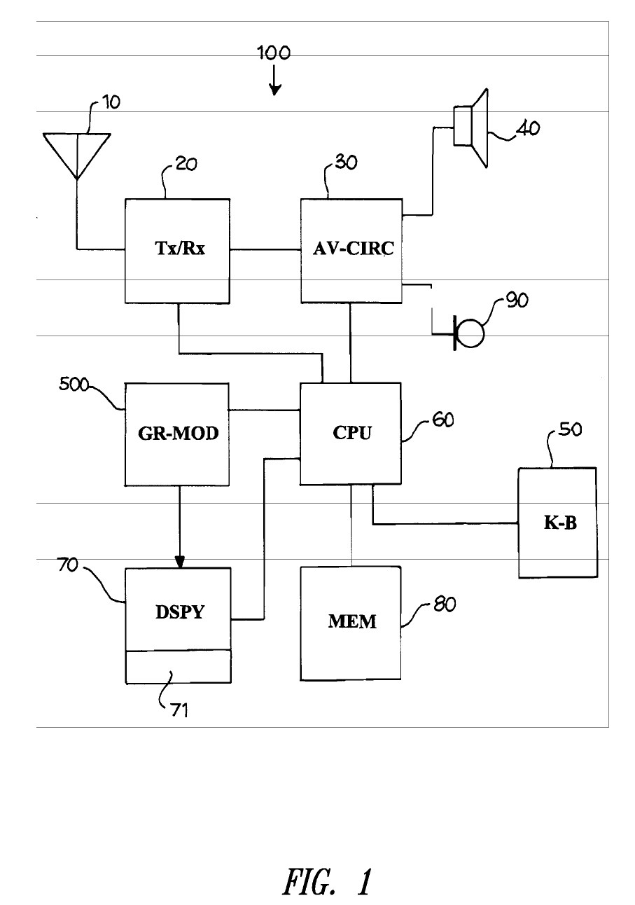

FIG. 1 shows a graphic system according to an embodiment of the invention and comprising a graphic module 500 (GR-MOD). The graphic system 100 illustrated in FIG. 1 is a mobile phone, but in accordance with further embodiments of the invention, graphic system 100 can be another system such as a personal digital assistant (PDA), a computer (e.g., a personal computer), a game console (e.g., PlayStation, etc.

As an example, the mobile phone 100 can be a cellular phone provided with an antenna 10, a transceiver 20 (Tx/Rx) connected with the antenna 10, an audio circuit unit 30 (AV-CIRC) connected with the transceiver 20. A speaker 40 and a microphone 90 are connected with the audio circuit unit 30.

The mobile phone 100 is further provided with a CPU (Central Processing Unit) 60 for controlling various functions and, particularly, the operation of the transceiver 20 and the audio circuit unit 30 according to a control program stored in a system memory 80 (MEM), connected to the CPU 60. Graphic module 500 is coupled to and controlled by the CPU 60. Moreover, mobile phone 100 is provided with a display unit 70 provided with a corresponding screen 71 (e.g., a liquid crystal display, DSPY), and a user interface 50, such as an alphanumeric keyboard (K-B).

The graphic module 500 is configured to perform a set of graphic functions to render an image on the screen 71 of the display 70. In one embodiment, the graphic module 500 is a graphic engine configured to render images, offloading the CPU 60 from performing such tasks. In one embodiment of the present invention the term “graphic engine” means a device which performs rendering in hardware. The terms “graphic accelerator”, also employed in the field, is equivalent to the term graphic engine.

Alternatively, the graphic module 500 can be a graphic processing unit (GPU) wherein the rendering functions are performed on the basis of hardware and software instructions. In accordance with a further embodiment, some or all of the rendering functions are performed by the CPU 60.

In FIG. 2 a diagram of the graphic module 500, is shown by means of functional blocks. Graphic engine 500 can perform the rendering of 3D (three dimensional) scenes that are displayed on the screen 71 of the display 70. Particularly, the graphic engine 500 can operate according to a sort-middle rendering approach (also called “tile based” rendering).

In accordance with the sort-middle rendering, the screen 71 of the display 70 is divided in a plurality of 2D (two dimensional) ordered portions (i.e., 2D tiles) such as, for example, square tiles 5 as shown in FIG. 7. As an example, the screen is divided into 2D tiles having size 16×16 pixels or 64×64 pixels.

The graphic engine 500, illustrated in FIG. 2, comprises a driver 501, a geometry stage 502 (also known as TnL stage—Transform and Lighting stage) a binner stage 503 and a parser stage 504.

The driver 501 is a block having interface tasks and is configured to accept commands from programs (e.g., application protocol interface—API) running on the CPU 60 and then translate them into specialized commands for the other blocks of the graphic engine 500.

The geometry stage 502 is configured to process primitives and apply to them transformations so as to move 3D objects. As defined above, a primitive is a simple geometric entity such as, e.g., a point, a line, a triangle, a square, a polygon or high-order surface. In the following reference will be made to triangles, which can be univocally defined by the coordinates of their vertexes, without other types of employable primitives.

The binner stage 503 is adapted to acquire from the geometry stage 502 primitive coordinates and associate them to each tile of the screen 71. The binner stage 503 is coupled to a scene buffer 504 which is a memory able to store information provided by the binner stage 503. As an example, the scene buffer 504 is a memory external to the graphic module 500 and can be the memory system 80 illustrated in FIG. 1.

The graphic module 500 further includes a parser stage 506, a rasterizer stage 507 and a fragment processor 508 which is coupled to the display 70. The parser stage 506 is responsible for reading, for each tile, the information stored in the scene buffer 504 and passing such information to the following stages also performing a primitive reordering operation.

The parser stage 506 generates an ordered display list which is stored, temporarily, in a parser side memory 509. The parser stage 506 is suitably coupled to the scene buffer memory 504 in order to read its content and is coupled to the binner stage 503 to receive synchronization signals.

According to one embodiment, the parser side memory 509 may be an on-chip memory, which allows a fast processing. As an example, the parser side memory 509 is integrated on the same chip on which the parser stage 506 has been integrated and, e.g., shows a capacity of 8 kB.

The rasterizer stage 507 is configured to perform processing of primitive data received from the parser stage 506 so as to generate pixel information images such as the attribute values of each pixel. The attributes are data (color, coordinates position, texture coordinate etc.) associated to a primitive. As an example, a triangle vertex has the following attributes: color, position, coordinates associated to texture. As is known to the skilled person, a texture is an image (e.g., a bitmap image) that could be mapped on the primitive.

The fragment processor 508 defines fragments from the received pixels, by associating a fragment depth to pixels and other data and performing suitable tests on the received pixels.

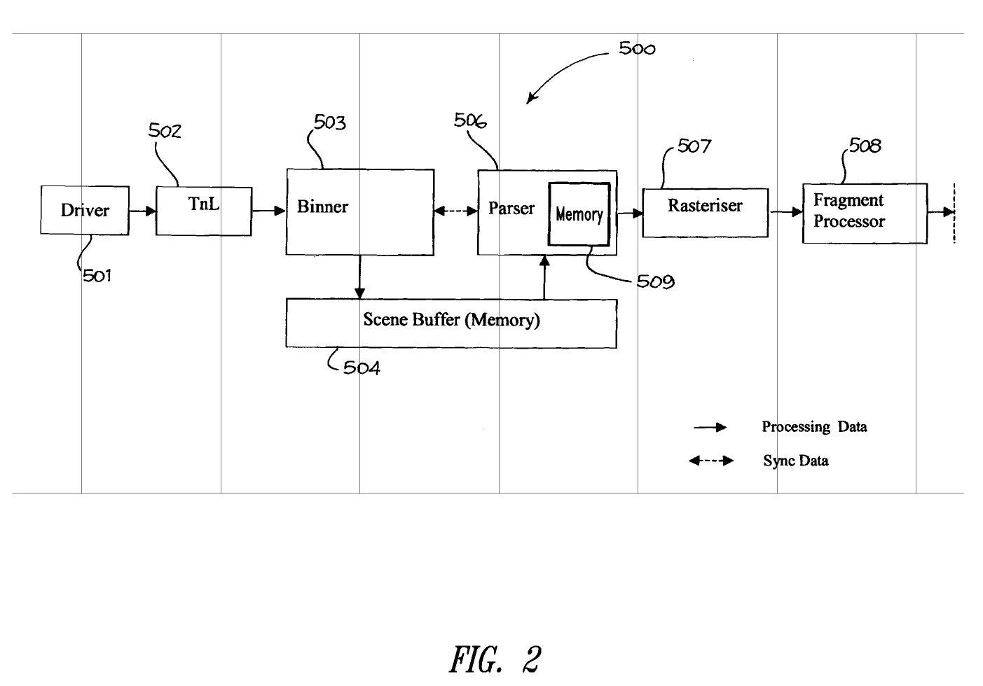

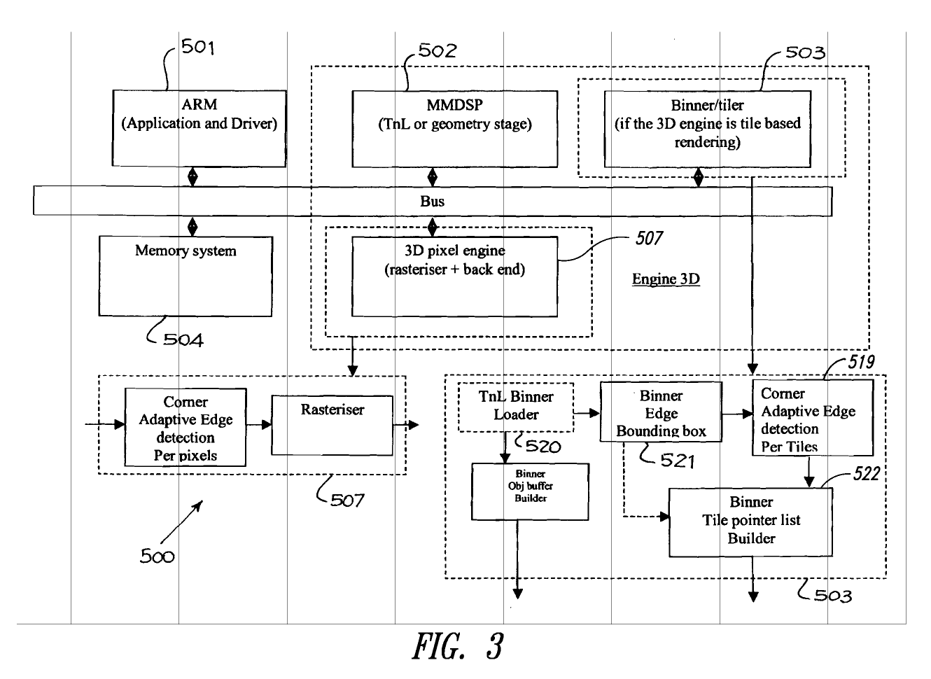

FIG. 3 shows an embodiment of the graphic module 500, wherein the binner module 503 and the rasterizer module 507 are disclosed in more detail. This architectural scheme is developed to work effectively in any 3D hardware (HW) accelerated graphics pipeline. In particular, the module 500 shown in FIG. 3 is oriented towards the integration into the Nomadik Platform (in particular the 8820 version), but it could be easily fitted into any real system that needs an HW accelerated 3D engine. In particular, binner module 503 includes a corner/edge detection module 519 suitable to perform a tiles edge detection process which will be described later, a geometry stage loader 520, a binner edge bounding box 521, which creates a bounding box around each primitive as will be described later in more detail, and a tile pointer list builder 522. The tile pointer list builder 522 builds the list of commands for each tile. Such commands can be pointers to contexts (for example, fog enable, blending enable, buffer format, etc.) or pointers to primitives that cross the tiles, detected by the corner/edge detection module 519. Afterwards, the graphic engine will read the sequence of commands of each tile, in order to rasterize the scene tile by tile.

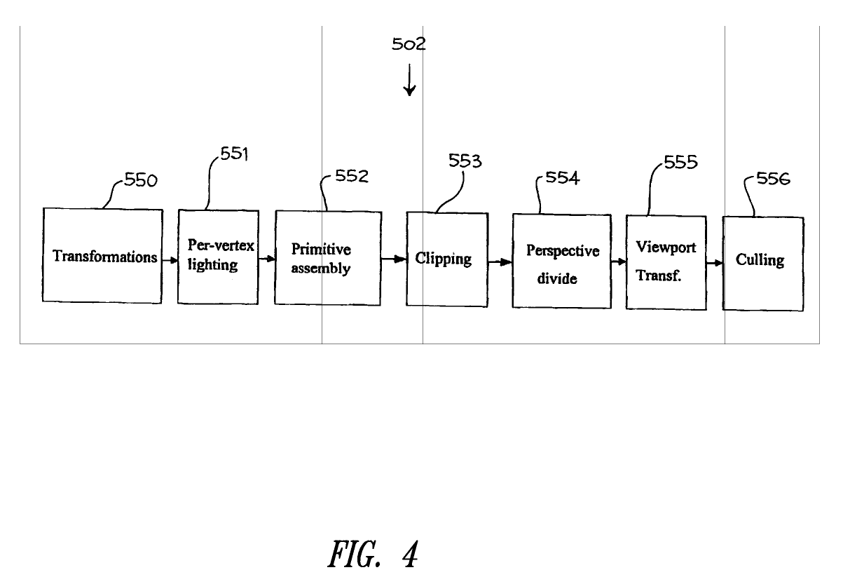

FIG. 4 shows an embodiment of the geometry stage 502 which includes a transformations stage 550. The transformations stage 550 is configured to apply geometric transformations to vertices of the primitives in each single object of the scene to transform primitives from a user space to a screen space. As an example, transformations are of the affine type and defined in an affine space where two entities are defined: points and vectors. Results of transformation are vectors or points.

Moreover, the particular geometry stage 502 described comprises: a lighting stage 551, a primitive assembly stage 552, a clipping stage 553, a “perspective divide” stage 554, a viewport transformation stage 555 and a culling stage 556.

The per-vertex lighting stage 551 applies light to the primitives depending on a defined light source and suitably adjusts the primitive color vertexes in such a way to define the effect of the light. The primitive assembly stage 552 is a stage that allows reconstruction of the semantic meaning of a primitive so as to specify the primitive type, i.e., specifying if a primitive is a triangle, a line or a point and so on.

The clipping stage 553 allows removal of the primitives that are outside the screen 71 (non-visible primitives) and converting the primitives that are placed partially out of the screen 71 into primitive which are fully visible. The perspective divide stage 554 is adapted to apply a projective transformation dividing each coordinate value by a vector w.

The viewport transformation stage 555 is configured to apply a further coordinates transformation which takes into account the screen resolution. The culling stage 556 has the task of removing the primitives oriented in a direction opposite to the observer and its operation is based on a normal direction associated to each primitive.

In operation, the user of the mobile phone 100 employs the keyboard 50 in order to select a 3D graphic application, such as a video game. As an example, such graphic application allows to show on the screen 71 several scenes. The scenes correspond to what is visible for an observer who can move assuming different positions. Accordingly, a software module corresponding to said graphic application runs on the CPU 60 and activates the graphic module 500.

A 3D scene to be rendered is included in a region of space, called view frustum VF (FIG. 5), which is the observer visible space. In FIG. 5, only a plane portion of the view frustum VF parallel to the screen 71 is shown. The clipping module 503 has the task to find said intersection between the screen 71 and the frustum VF.

The binner stage 503 associates empty tiles with the triangle to avoid redundant rasterizer calculations. It is clear that, if triangles are smaller then tiles, the binner stage 503 processes all triangles within each tile before proceeding to the next tile. If the triangles are larger than tiles, it associates the triangles with all the tiles they cross and stores the state. In this case, an exploration of the tiles is carried out.

According to one embodiment, the binner module 503 is adapted to detect the tiles crossed by the edges of a triangle (border tiles), as described later in more detail. All the tiles between two border tiles on the same row are then considered included in the primitive and may therefore be stored.

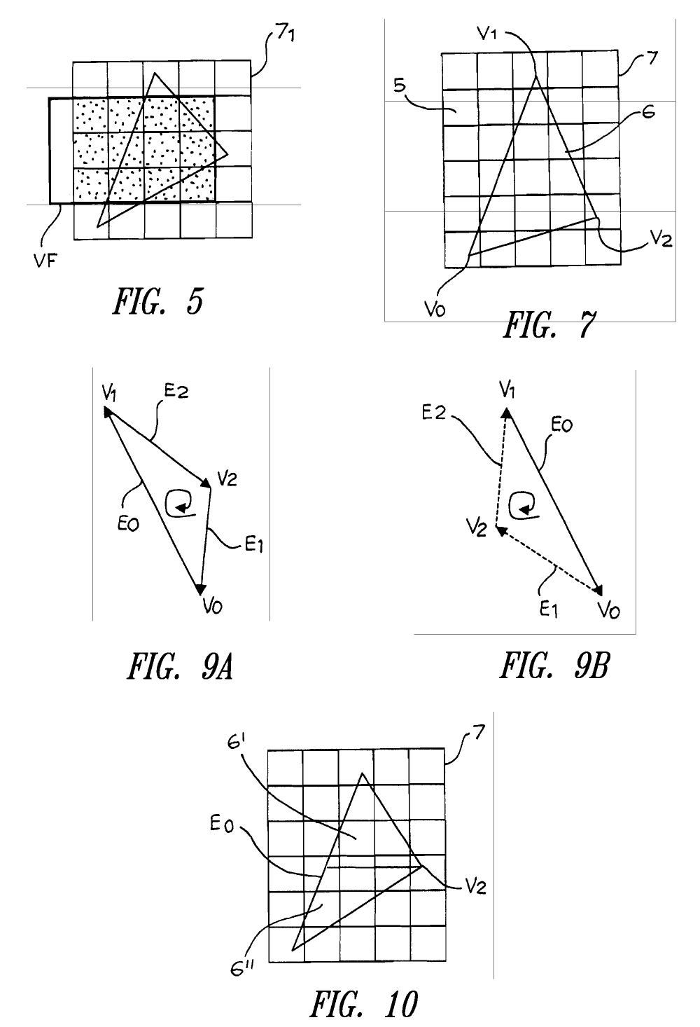

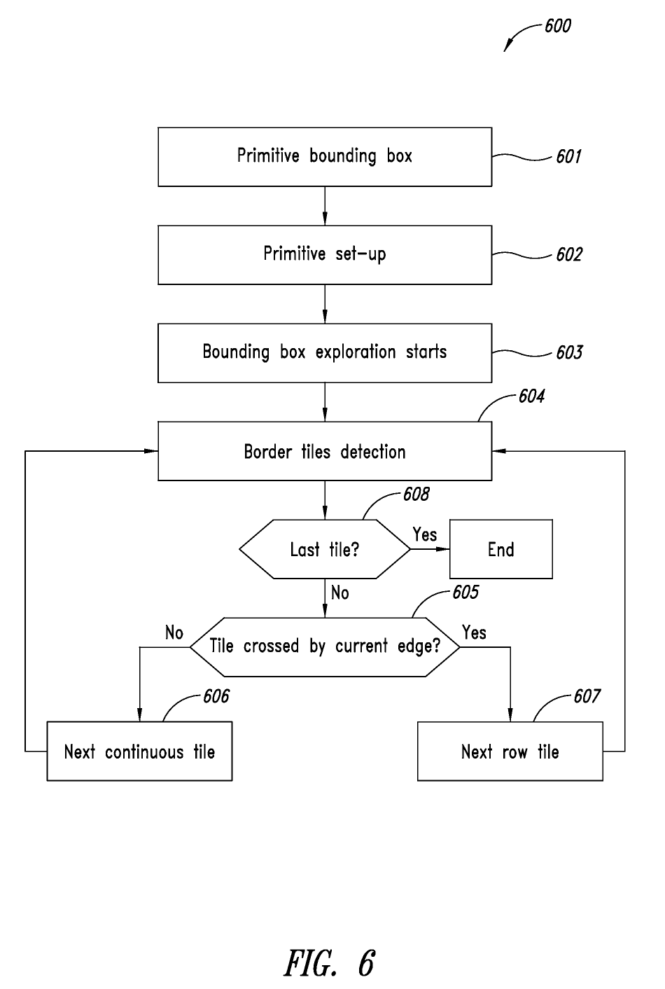

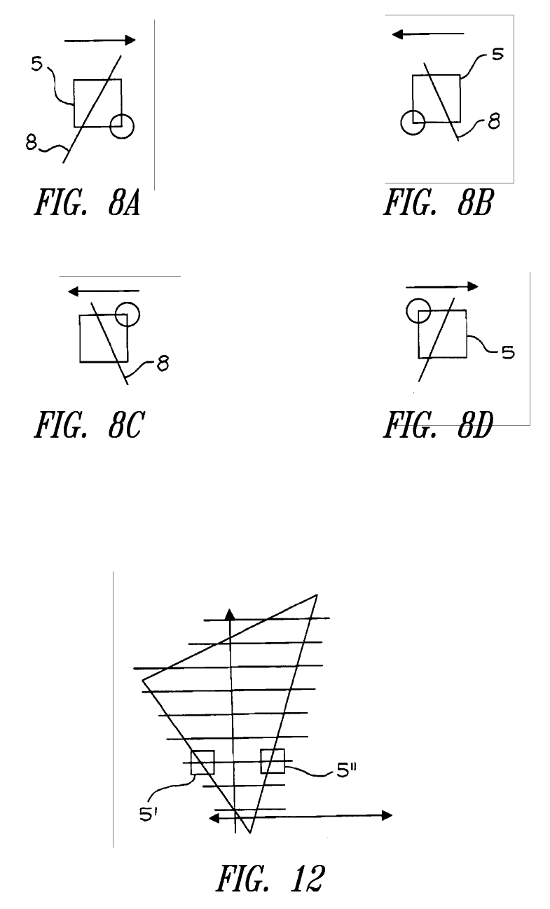

FIG. 6 shows, by means of a flow chart, a method 600 for detecting the border tiles of a primitive defined by at least three vertexes V0=(x0, y0), V1=(x1, y1) and V2=(x2, y2), in accordance with one embodiment of the invention. Particularly, the method can be performed by the binner module 503. In one embodiment, the float values of x,y coordinates of the vertexes of a primitive are scaled with the dimension of the screen in tile units.

Method 600 is directed to detect the tiles covered by a primitive in the form of a triangle 6 defined by three vertexes. It has to be noted, however, that the method here described is also applicable to other polygons, since it is always possible to decompose a polygon in triangles.

According to one embodiment, before starting the exploration of the tiles, the binner module 503 defines, by means of computations, a bounding box 7 around the triangle 6 (step 601 and FIG. 7). Only tiles in the bounding box are candidates as covered tiles for the primitive. Having scaled the vertex coordinates, it is easy to bound because it is sufficient to make a rounding of x, y coordinates into integer coordinates to know the position of a tile.

In a step 602, the binner module 503 performs a primitive set up phase, in which for each couple of vertexes the equation of the line passing through the vertexes is calculated in the form of the following edge equation:

E=x(y1−y0)−y(x1−x0)−x0(y1−y0)−y0(x1−x0)=ax+by+c

Any point on the line will satisfy this equation; points not belonging to the line and placed on one side will give a positive result, while points not belonging to the line and placed on the other side will give a negative result. Therefore, the edge equation can be used to determine on which side of a line a point is placed.

The three edge equations of the triangle will be:

E0=x(y1−y0)−y(x1−x0)−x0(y1−y0)−y0(x1−x0)=a01x+b01y+c01

E1=x(y2−y0)−y(x2−x0)−x0(y2−y0)−y0(x2−x0)=a02x+b02y+c02

E2=x(y1−y2)−y(x1−x2)−x2(y1−y2)−y2(x1−x2)=a21x+b21y+c21

In the set up phase, the binner module 503 defines if an edge is left or right and the sign of the slope of each edge. According to this information, the binner module 503 selects, for each edge, the tiles scan direction and just one corner of the tile to be evaluated. In fact, given a scan direction and the slope of an edge, it is sufficient to test just a corner of a tile to check if the tile is crossed by the edge.

More in detail, the following four combinations can occur for an edge 8 (FIG. 8):

a. Left edge and positive slope;

b. Left edge and negative slope;

c. Right edge and positive slope; and

d. Right edge and negative slope.

In the set up phase the binner module 503 performs the following selection:

If an edge 8 is left and has a positive slope (case a), the tiles scan direction is from left to right and the tile corner to be evaluated is the bottom-right (FIG. 8A);

if an edge 8 is right and has a negative slope (case b), the tiles scan direction is from right to left and the tile corner to be evaluated is the bottom-left (FIG. 8B);

if an edge 8 is left and has a negative slope (case c), the tiles scan direction is from right to left and the tile corner to be evaluated is the top-right (FIG. 8C);

if an edge is right and has a positive slope (case d), the tiles scan direction is from left to right and the tile corner to be evaluated is the top-left (FIG. 8D).

According to one embodiment of the invention, for determining if an edge is left or right, the binner module 503:
selects a reference edge between two vertexes;
tests the sign of the reference edge equation for the third vertex, and:
   if the sign is positive, marks the reference edge as a left edge;
   if the sign is negative, marks the reference edge as a right edge.

As an example shown in FIGS. 9A and 9B, the binner module 503 selects as reference edge the edge with the maximum Δy, i.e., the edge showing the maximum value of the difference between the y coordinates of the corresponding vertexes. In this case, the third vertex is a middle vertex, along the y axes. It has to be noted that in the phase of construction of the bounding box the top and bottom values of the y coordinates have already been searched and marked, for example, as indexMaxY and indexMinY. Advantageously, if the values 0, 1 and 2 are associated with the three vertexes, the index of the middle vertex can be calculated with the formula:

indexMiddle=3−indexMaxY−indexMinY.

As stated above, to verify if a point is inside or outside a primitive, the sign of the edge equation may be tested. The line equation could be ax+by+c=0 or −ax−by−c=0, so the sign of the edge equation depends on the sign of the coefficients. According to one embodiment, it is better to have always an internal point with a positive edge equation for all edges, so it is not necessary to change sign of edge equation every time. In other words, the coefficients sign of the edge equation of the left and right edges is chosen such that the results of the edge equations for a point falling between the left and right edges have the same sign.

Then it is sufficient to follow a clockwise direction to define the sign of coefficient.

With reference to FIG. 9, if E0 is the reference edge and V2 the middle vertex, if the corresponding edge equation evaluated for V2 gives a positive result, E0(V2)>0, then the middle vertex is right and the sign of a21, b21, c21 and a02, b02, c02 may be changed to have an internal point with E0, E1, E2 positive (FIG. 9A).

If E0(V2)<0, then the middle vertex is left and the sign of a01, b01, c01 may be changed to have an internal point with E0, E1, E2 positive (FIG. 9B).

A winding equation (cross product between two vectors) gives the same result as the edge equation, so they are equivalent.

According to one embodiment, the set up phase 602 of the method also includes a splitting of the triangle 6 into a top sub-triangle 6′ and a bottom sub-triangle 6″. In more detail, a line E3 parallel to the tiles scan direction, horizontal in the example here described, is drawn from the middle vertex V2 towards the reference edge E0. In this way, in each sub-triangle the left and right edges have the same Δy.

Having determined, for each edge, the scan direction and the tile corner to be evaluated, the binner module 503 can start the exploration of tiles to discover which are crossed by the edges (step 603).

It has to be noted that left and right edges and edge slope sign are calculated once in the set up phase for the selection of the scan direction and of the tile corner. During the scan line of an edge, the direction and the tile corner is always the same.

As stated above, according to one embodiment, the tiles exploration process is not a full exploration of the bounding box, but an exploration along a scan line defined by an edge. At the beginning of the process a first row may be explored, for example the row including the vertex with the minimum y coordinate, starting from an end (step 604). The process ends after determining that the previous tile evaluated was the last tile (step 608).

When a border tile is detected, its position is used for determining the starting point for the tiles exploration along an adjacent row.

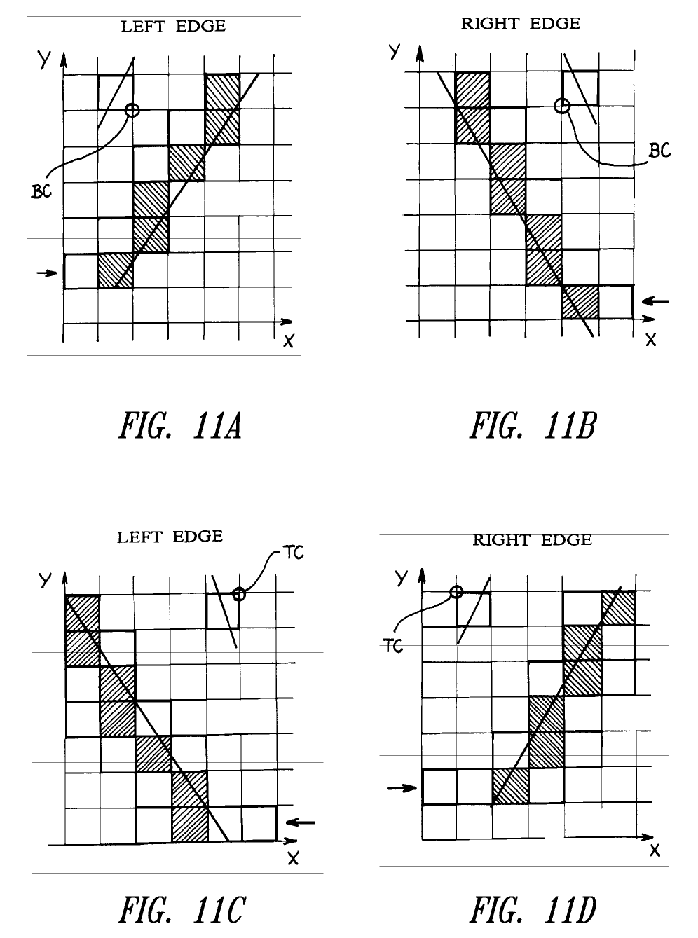

FIGS. 11A-11D represent an example of an incremental process of evaluation of the tile crossed by an edge. In these figures, the tiles in bold are the tiles tested, while the shadowed tiles are those crossed by the edge. In more detail, if, for an edge, the tile corner to be evaluated is the bottom corner (in FIGS. 11A, 11B indicated with the reference BC), the exploration is of the bottom of the tiles along a row and takes place until the edge equation for that corner is negative (steps 605, 606) and terminates when the edge equation becomes positive (steps 605, 607), that is, when a tile is crossed by the edge under evaluation. The tile exploration along the next row will start from the same X coordinate of the position of said crossed tile.

If, instead, the tile corner to be evaluated is a top corner (in FIGS. 11C, 11D indicated with the reference TC), the exploration of the tiles along a row takes place until the edge equation for that corner is positive and terminates when the edge equation becomes negative, that is when a tile is not crossed by the edge under evaluation. In this case, the tiles exploration along the next row will start from the X coordinate of the position of last tile crossed by the edge.

In any case, except for the first row, when the algorithm changes row it is not necessary to restart from the first tile of the row. Considering the exploration made by row, the edge equation is calculated in an incremental way except for start row tiles, such that E new=E old+K.

It means only one sum instead of the 2 sums and 2 multiplications of the edge equation in the usual extended form: E=a*x+b*y+c.

When a tile is found to be crossed by an edge, it is marked as a start tile 5′ (if the edge is left) or as an end tile 5″ (if the edge is right). When all the edges have been explored, all the tiles comprised by a start tile and an end tile of a row are considered to be covered by the primitive and therefore are stored in the scene buffer (FIG. 12).

It is evident from the description above that the method of finding border tiles according to one embodiment of the invention does not require to evaluate the edge equation of all tile corners and of all three edges, but of just one corner and just one edge. Therefore, the method here proposed is 12 times less complex.

Advantageously, it is possible to use this technique also in the case represented in FIG. 5 of vertices out of frustum (out of screen). This case could happen if some primitives are clipped. Since this method makes calculations only inside the corners of the bounding box, it does not depend on clipping. On the contrary, some techniques always start from the lowest vertex, but if it is out of screen it needs the classic clipping to avoid useless evaluations out of screen. Hence adaptive corner does not suffer clipping.

Another advantage of the method according to one embodiment of the invention is that it can be also used to find border pixels of a primitive into rasterizer stage 507, for example starting edge equation evaluation from the center of the pixel.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A binning method, comprising:
detecting border tiles of a primitive defined by at least three vertexes, the detecting including:
defining a left edge and a right edge of the primitive compared to a direction of exploring tiles;
calculating a slope sign for the left edge using an edge equation for said left edge and calculating a slope sign for the right edge using an edge equation for the right edge; and
checking if a tile is crossed by one of said edges by evaluating the edge equation of the one of said edges with respect to a single corner of a tile, the corner being selected according to the one of said edges being a left or a right edge and according to the slope sign of the one of said edges.

2. The method according to claim 1, wherein the corner being selected is:
for a left edge with a positive slope sign, a bottom-right corner;
for a left edge with a negative slope sign, a top-right corner;
for a right edge with a positive slope sign, a top-left corner; and
for a right edge with a negative slope sign, a bottom-left corner.

3. The method according to claim 1, wherein a coefficient sign of the edge equations of the left and right edges is chosen such that results of the edge equations for a point falling between the left and right edges have a same sign.

4. The method according to claim 3, comprising:
selecting a reference edge between two vertexes;
testing a sign of a reference edge equation for a third vertex;
if the sign of the reference edge equation is positive, changing the coefficient sign of the edge equations for the left and right edge; and
if the sign of the reference edge equation is negative, changing a sign of a coefficient of the reference edge.

5. The method according to claim 1, wherein defining a left edge and a right edge comprises:
selecting a reference edge extending between two vertexes;
testing a sign of a reference edge equation for a third vertex, such that:
if the sign of the reference edge equation is positive, then the reference edge is a left edge;
if the sign of the reference edge equation is negative, then the reference edge is a right edge.

6. The method according to claim 5, wherein the reference edge is an edge showing a maximum value of a difference between a coordinate of corresponding vertexes, the third vertex being a middle vertex.

7. The method according to claim 6, wherein, before starting the tiles exploration, an edge parallel to the direction of exploring tiles is created from the middle vertex forming a bottom sub-triangle and a top sub-triangle.

8. The method according to claim 1, wherein exploring tiles is performed row by row.

9. The method according to claim 8, wherein the direction of exploring tiles is from left to right for an edge with a positive slope sign, and from right to left for an edge having a negative slope sign.

10. The method according to claim 8, wherein, when a border tile is detected, a position of the border tile is used for determining a starting point for the exploring tiles along an adjacent row.

11. The method according to claim 10, wherein, if the corner of a tile to be evaluated is a bottom corner, the tiles exploration along a first row terminates when a tile in the first row is crossed by an edge under evaluation and the tiles exploration along a second row starts from an X coordinate of a position of the tile that is crossed in the first row.

12. The method according to claim 10, wherein, if the corner of a tile to be evaluated is a top corner, the tiles exploration along a first row terminates when a tile in the first row is not crossed by an edge under evaluation and the tiles exploration along a second row starts from the an X coordinate of a position of a last tile of the first row crossed by the edge.

13. The method according to claim 8, wherein a first row to be explored is a row including a vertex of a primitive with a minimum Y coordinate.

14. The method according to claim 1, wherein, before starting exploring tiles, a bounding box is associated with the primitive.

15. The method according to claim 1, wherein the primitive is one of a plurality of primitives that are triangles, which each define a frame of three-dimensional data; and the defining, calculating, and checking steps are performed for each triangle; the method further comprising assigning the triangle to tiles in a memory buffer.

16. The method according to claim 15, comprising:
processing the triangles and applying to them transformations so as to move 3D objects.

17. The method according to claim 16, wherein processing step comprises:
applying geometric transformations to vertices of the triangles in each single object of a scene to transform triangles from a user space to a screen space;
applying light to the triangles depending on a defined light source and suitably adjusting colors of the vertices to define the effect of the light;
specifying if a primitive is a triangle, a line or a point;
removing primitives that are outside the screen space and converting primitives that are placed partially out of the screen space into primitives which are fully visible;
applying a projective transformation dividing each coordinate value by a vector w;
applying a coordinates transformation which takes into account a screen resolution; and
removing primitives oriented in a direction opposite to an observer.

18. The method according to claim 15, further comprising:
reading, for each tile, information associated therewith, and performing a primitive reordering operation and passing the information to:
a rasterizer stage arranged downstream of a parser stage for processing primitive data received from the parser stage so as to generate pixel information images; and
a fragment processing stage arranged downstream the rasterizer stage for defining fragments from received pixels, by associating a fragment depth with pixels and other data and performing suitable tests on the received pixels.

19. A graphic module, comprising:
a geometry stage, suitable for processing primitives each representing a model of an object to be displayed on a screen; and
a binner module arranged downstream of said geometry stage and suitable for acquiring from the geometry stage primitive coordinates and associating them to tiles of the screen, wherein said binner module is configured to perform:
a set up phase in which, for each edge of a primitive and for each tile, only one corner of the tile and a tiles scan direction are selected according to the edge being a left or a right edge and according to a slope of the edge; and
a tiles exploration phase, in which, for each edge of the primitive and for each tile, it is checked if the tile is crossed by said edge by evaluating a position of said corner in comparison to the edge.

20. The graphic module according to claim 19, wherein the binner module receives from the geometry stage three vertexes of a triangle representing a primitive, defines a left edge and a right edge of the primitive with respect to a tiles exploration direction, and calculates an edge equation for said left and right edges, in such a way to define a slope sign thereof.

21. The graphic module according to claim 20, wherein, for defining a left edge and a right edge, the binner module is configured for selecting a reference edge between two vertexes and testing a sign of a reference edge equation for a third vertex.

22. The graphic module according to claim 21, wherein the binner module is configured for:
selecting as a reference edge an edge with a maximum change in a Y coordinate;
testing the sign of the reference edge equation for the third vertex; and
if the sign of the reference equation is positive, changing a sign of the coefficients of two other edge equations;
if the sign of the reference equation is negative, changing a sign of a coefficient of the reference edge.

23. The graphic module according to claim 19, wherein the binner module is configured for splitting a triangle representing a primitive into two sub-triangles, the two sub-triangles having an edge in common, the edge in common being parallel to a tiles exploration direction.

24. The graphic module according to claim 19, wherein the binner module operates sequentially on rows of tiles and changes rows when the last tile is crossed by an edge under evaluation.

25. The graphic module according to claim 19, wherein the binner module is configured to perform an incremental tiles exploration along an edge.

26. The graphic module according to claim 25, wherein, when the tile exploration along a row terminates at an X coordinate, the binner module is configured to store said X coordinate and to start exploration of a new tile row from said X coordinate.

27. The graphic module according to claim 19, wherein the binner module is configured, before starting the tile exploration, for constructing a bounding box around a primitive received from the geometry stage.

28. The graphic module according to claim 19, wherein, when border tiles are discovered for a left and a right edge of a primitive, the binner module is configured for storing in a memory buffer all tiles between said border tiles.

29. The graphic module according to claim 19, further comprising:
a parser module arranged downstream of the binner module and suitable for reading, for each tile, information associated thereto, performing a primitive reordering operation and passing such information to following stages; and
a rasterizer module configured to perform processing of primitive data received from a parser stage so as to generate pixel information images.

30. An apparatus comprising:
a screen divided into a plurality of tiles; and
a graphic engine circuit structured to render an image on the screen, the graphic engine circuit being structured to:
define a left edge and a right edge of a primitive of a model of the image;
define slope signs of said left and right edges;
check whether a tile is crossed by one of said left and right edges by evaluating an edge equation of the one of said edges with respect to only one corner of the tile, the corner being selected according to the one of said left and right edges being a left or a right edge and according to the slope sign of the edge; and
store in a memory information associated with border tiles crossed by at least one of the edges and with tiles of the screen delimited by said border tiles.

31. The apparatus according to claim 30, wherein the graphic engine circuit is structured to select, as the only one corner of the tile being evaluated:
for a left edge with a positive slope sign, a bottom-right corner;
for a left edge with a negative slope sign, a top-right corner;
for a right edge with a positive slope sign, a top-left corner; and
for a right edge with a negative slope sign, a bottom-left corner.

32. The apparatus according to claim 30, wherein a tiles exploration direction is from left to right for an edge with a positive slope sign, and from right to left for an edge having a negative slope sign.

33. The apparatus according to claim 30, wherein, for defining the left edge and the right edge, the graphic engine circuit is structured to:
select a reference edge between first and second vertexes;
test a sign of a reference edge equation for a third vertex, such that:
if the sign of the reference edge equation is positive, then the reference edge is a left edge;
if the sign of the reference edge equation is negative, then the reference edge is a right edge.

34. The apparatus according to claim 30, wherein the graphic engine circuit is to select coefficients sign of the edge equations in such a way that results of the edge equations for a point falling within the primitive have a same sign.

35. The apparatus according to claim 30, wherein the primitive is a triangle and the graphic engine circuit is structured to split the triangle into a bottom sub-triangle and a top sub-triangle, each sub-triangle being defined by a left edge, a right edge, and a horizontal edge.
